(19) United States
(12) Patent Application Publication
(10) Pub. No.: US 2010/0066161 A1
(43) Pub. Date: Mar. 18, 2010

(54) Trailer Electronic Braking System

(75) Inventors: Matthew FRY, Wraxall (GB); Martin Mederer, Neumarkt (DE); Kornel Straub, Pomaz (HU); Valer Merza, Szentendre (HU); Gergely Szabo, Budapest (HU)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE Systeme fuer Nutzfahrzeuge GmbH, Muenchen (DE)

(21) Appl. No.: 12/561,654

(22) Filed: Sep. 17, 2009

Related U.S. Application Data
(63) Continuation of application No. PCT/GB2008/001026, filed on Mar. 25, 2008.

(30) Foreign Application Priority Data
Mar. 22, 2007 (GB) 0705522.1

(51) Int. Cl. B60T 8/17

(52) U.S. Cl. 303/9.66

(57) ABSTRACT

A trailer electronic braking system for a road train includes a tractor and a plurality of trailers. The braking system includes a braking ECU on at least one trailer and an ABS system on a further trailer. A communication interface is provided so that the braking ECU on a first trailer and the ABS control unit on a second trailer are able to communicate with one another. In use, the braking ECU on the first trailer receives an input from a respective sensor on the first trailer adapted to detect lateral acceleration anchor wheel speed. In the event that the sensor detects lateral acceleration anchor a wheel speed indicative of a loss of stability, the sensor generates a signal for actuating stability control, which signal is passed via the communication interface to the ABS control unit on the other trailer, so that the other trailer can actuate the brakes on that trailer.

### CROSS-REFERENCE TO RELATED APPLICATIONS

This application is a continuation of PCT International Application No. PCT/GB2008/001026, filed Mar. 25, 2008, which claims priority under 35 U.S.C. §119 to Great Britain Patent Application No. 0705522.1, filed Mar. 22, 2007, the entire disclosures of which are herein expressly incorporated by reference.

This application contains subject matter related to U.S. application Ser. No. ______, entitled “Trailer Electronic Braking System,” filed on even date herewith.

### BACKGROUND AND SUMMARY OF THE INVENTION

The invention relates to a trailer electronic braking system for motor vehicles having a plurality of trailers.

In Australia and North America, vehicles consisting of a tractor unit and two or more trailers are commonly utilized and these are collectively termed “road trains”. Road trains are not currently permitted in Western Europe due to weight limits on the size of vehicles; however, due to the environmental and cost advantages of road trains, it is likely that this will change.

In all these territories there are a large number of small engineering companies building trailers for various tractors employing compressed air operable brakes. Such trailer builders tend to specialize in specific vehicle types, but to meet statutory requirements, it is a common feature that trailers are provided with means which control the braking force signaled from a towing tractor. These trailer braking systems are now invariably electronic braking systems (EBS) having electronic control by an ECU. It is now routine that the electronic braking systems can incorporate features such as stability control. Stability control has proved to be a major safety enhancement.

Tractors are commonly provided with electronic stability control such as ESP®, which can generate an additional brake demand on the trailer but cannot provide full stability control on the trailer, only on the tractor. Trailers are therefore provided with roll stability control (RSP). Trailer roll stability control monitors the lateral acceleration on the trailer as a build-up of lateral acceleration leads to a rollover of the trailer, as well as providing selective brake application and monitoring wheel speeds to detect any wheel lift which generates abnormal rotational speeds. The commonest rollover situations include where a driver steers rapidly in one direction and then back in the opposite direction, for example to avoid an obstruction on the motorway. In this situation, the ECU is able to make a predictive intervention to stabilize the vehicle by controlling the brake force at either an axle or individual wheel level. The other common rollover situation is where there is a slow build-up of lateral acceleration on the trailer on, for example, a motorway exit, where a small selective brake application to the inside (with respect to the curve) wheels may result in a large change in velocity. In this case, the ECU can apply a large brake effort to the rear axles to stabilize the vehicle.

Known RSP systems suffer from the problem that they cannot simply be extended to road trains as clue to the increased size of the vehicle, it may take too long for the lateral acceleration signal to be measured, processed and the brake demand adjusted before the rollover event occurs. This will be particularly the case if the center of gravity of the vehicle is towards the rear of the train.

For the foreseeable future with road trains, there will be an additional problem involving mixed trailers such as where one trailer has a modern EBS but the other trailer is older and only has ABS.

The present invention therefore seeks to provide a trailer braking system adapted to provide roll stability control for road trains, in particular road trains having mixed trailers.

According to the invention, there is provided a braking system for a motor vehicle having a plurality of trailers, wherein a first trailer is provided with a braking system comprising a braking device capable of generating a braking force on an axle on the trailer, a brake force into the brake cylinders being controllable by a first braking ECU in dependence on an output of a sensor adapted to detect lateral acceleration and/or wheel speed on the first trailer, and wherein a second trailer is provided is provided with a braking system comprising a braking device capable of generating a braking force on an axle on the trailer, a brake force into the brake cylinders being controllable by an ABS valve having a second braking ECU. A communication interface is provided so that the ABS valve is controllable by the first braking ECU, wherein, in the event that the sensor detects lateral acceleration and/or a wheel speed indicative of loss of stability, the sensor generates a signal for actuating stability control in the first trailer and the first braking ECU generates a signal to apply the brakes on the second trailer.

The communication interface could be pneumatic, electrical or electronic. Preferably, the communication interface is a CAN bus or powerline carrier. Preferably, the sensor is a lateral acceleration sensor and/or two or more wheel speed sensors. Preferably, the sensor generates a signal only when the lateral acceleration detected exceeds a predetermined threshold. Preferably, the braking ECU monitors the wheel speed on the first trailer, wherein stability control is initiated as a function of whether the vehicle is braked or unbraked through a braking intervention by monitoring the rotational wheel speed behavior. Preferably in a case of a braked vehicle, the brake pressure is lowered at the brake cylinder of the wheel on the inside of a turn and a stability control event initiated if the rotational speed of the wheel increases by less than a predetermined amount.

The invention advantageously improves vehicle stability control in a road train as the risk of braking the trailer individually can lead to instability in the other trailers on the road train thereby increasing the risk of rollover. It also allows RSP emulation on a trailer that is not provided with RSP. The invention also advantageously decreases the time between lateral acceleration on the train being detected and stability control being initiated.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a trailer electronic braking system;

FIG. 2 shows a schematic of a road train using ISO 11992 where the first trailer has EBS;

FIG. 3 shows a schematic of a road train using J2497 SAE where the first trailer has EBS;

FIG. 4 shows a schematic of a road train using ISO 11992 where the second trailer has EBS; and

FIG. 5 shows a schematic of a road train using J2497 SAE where the second trailer has EBS.

### DETAILED DESCRIPTION OF THE DRAWINGS

Referring to the Figures, the utility or commercial vehicle trailer has a steerable front axle with front wheels 1, 2 and a rear axle with rear wheels 3, 4. Rotational wheel speed sensors 5-8 are in each case assigned to the front wheels 1, 2 and the rear wheels 3, 4, and are connected by way of electric lines 9-12 with an electropneumatic brake pressure control module 13 (EBS module), which is primarily assigned to the rear axle brakes. One brake 14-17 is in each case assigned to the front wheels 1, 2 and the rear wheels 3, 4, which brake 14-17 can be applied by way of brake cylinders 18, 19 of the front axle or spring-loaded brake cylinders 20, 21 of the rear axle.

The braking system of the trailer vehicle can be connected by way of three connections, specifically a pneumatic supply line connection 22, a pneumatic control line connection 23 and an electric control connection 24, with the braking system of a tractor or a further trailer.

The supply line connection 22 is connected by way of a return valve 25 and a parking valve 26 with an air brake reservoir 27. From the air brake reservoir 27, a pneumatic line 28, 31 leads to a supply input of the pressure control module 13 and ABS valve 32. In addition, a pneumatic line 29 branches off the parking valve 26 to the pressure control module 13. A pneumatic line 30 extends between the parking valve 26 and the air brake reservoir 27.

The ABS valve 32 is assigned jointly to both brake cylinders 18, 19 of the front axle and is connected with the brake cylinder 18 by way of a pneumatic line 33 and with the brake cylinder 19 by way of a pneumatic line 34. The ABS valve 32 has two electric control inputs which are connected by way of “one” electric line 35 (shown here only schematically) with the pressure control module 13.

Furthermore, the ABS valve 32 has a pneumatic control input 36 which is connected by way of a return valve 37 with the pneumatic control connection 23. The pneumatic control input 36 is also connected by way of a pneumatic control line 38 with a pneumatic control input of the pressure control module 13. The pressure control module 13 has an integrated pressure sensor (not shown), which measures the pressure in the pneumatic control line 38, that is, the control pressure present at the pneumatic control input 36 of the ABS valve, which control pressure is identical to the maximal pressure which can be controlled into the brake cylinders 18, 19.

The pressure control module 13 has pneumatic outputs 39, 42, which are connected by way of assigned pneumatic lines with the spring brake cylinders 20 or 21.

Furthermore, pneumatic axle load sensors or air bellows 43, 44 are provided at the rear axle and permit a determination of the axle load, particularly of the dynamic axle load during braking and starting. The axle load sensors 43, 44 are connected by way of electric lines with the pressure control module 13 which is shown here only as an example by way of the electric line 55. Correspondingly, axle load sensors 45, 46 may be provided at the front axle. However, the axle load sensors 45, 46 are not absolutely necessary.

To provide stability control, a lateral acceleration sensor 50 is provided, which may also be integrated with a yaw sensor, and the output of the lateral acceleration sensor is fed to the pressure control module/ECU 13. Typically, the lateral acceleration sensor 50 is integrated into the pressure control module/ECU 13. In the event that lateral acceleration on the trailer is detected, the pressure control module can provide for increased brake force at the front and/or rear axles. When the lateral acceleration sensor 50 detects lateral acceleration on the trailer in which it is installed, the sensor generates a signal setting the stability control to active.

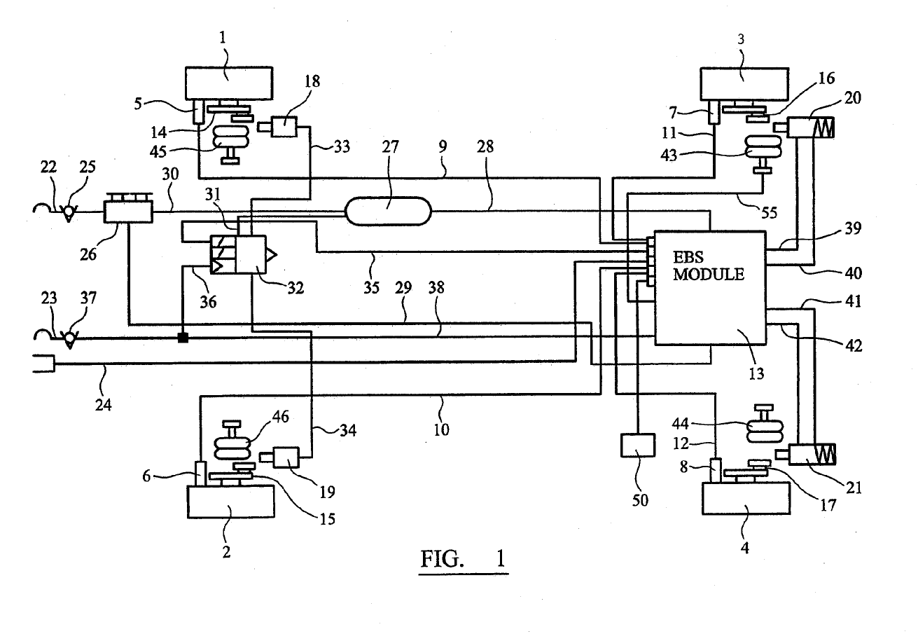

With respect to the embodiment described in FIG. 1, the ABS valve 32 may be replaced with an electro-pneumatic valve where the electric control line 35 consists of a communication interface preferably a CAN and an electric power source.

In a road train having mixed trailers, where one trailer has EBS and one has ABS, the pressure control module 13, the ABS ECU and valve on the ABS trailer will be connected to the ECU 13 and controlled by it in an analogous fashion to valve 32.

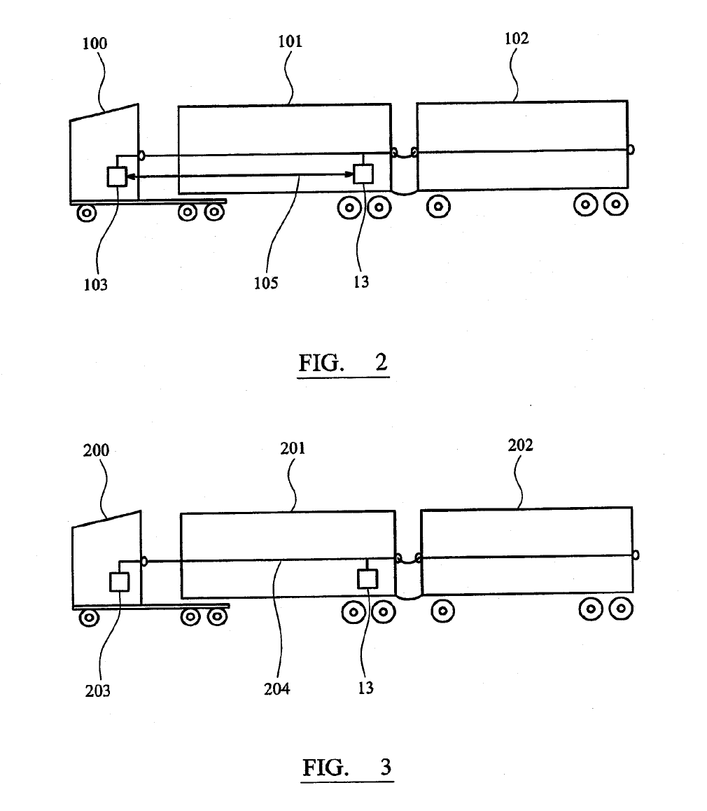

FIGS. 2 and 3 show schematically how the signals can be processed in a road train based on the International standard governing communications between tractors and trailers, ISO 11992 and the US standard for governing communications between tractors and trailers J2497SAE.

FIG. 2 shows schematically a tractor unit 100 connected to a first trailer 101, which in turn is connected to a second trailer 102. The tractor is provided with a braking ECU 103 and the first trailer 101 is provided with an electronic braking system having a pressure control module including a braking ECU 13, described in greater detail above. The second trailer 102 has a conventional ABS braking system. Pursuant to ISO 7638, a separate power line is provided along the length of the road train to provide power to the braking ECUs. In the event that the lateral acceleration sensor on trailer 101 detects lateral acceleration, a vehicle dynamic control signal setting the vehicle dynamic control (VDC) parameter to active is sent both ways on the CAN bus 105. If the lateral acceleration sensor on the trailer 102 detects lateral acceleration, the signal setting the VDC parameter to active is sent via the CAN bus 105 to any other trailers having an ECU and then to the tractor 100. The signal does not have to provide further information such as purpose. If the braking ECU 13 or 103 detects a VDC active parameter, stability control can be activated. The tractor 100 can therefore perform functions such as disabling cruise control and stopping the gearbox from downshifting when the brakes are applied. The active ECU 13 can enable braking functions in other trailers where an ECU is not present.

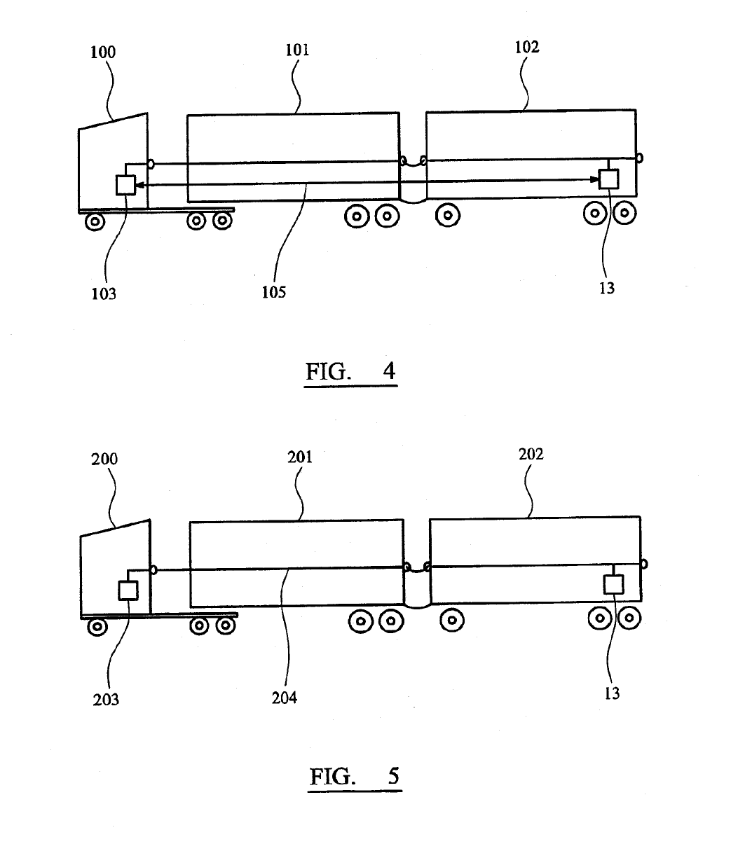

FIG. 4 shows an analogous arrangement where the pressure control module ECU 13 is located on the second trailer 102 instead of the first trailer and operates in a similar way.

FIG. 3 shows schematically a road train using a powerline carrier in accordance with the SAE standard J2497, including a tractor 200, first trailer 201 and second trailer 202. The tractor 200 and one of the trailers 201 are provided with respective braking ECU 203 and pressure control module/ECU 13, but in this case the communication between the braking ECU's is via the powerline rather than via a separate CAN bus. In this case, the lateral acceleration sensors are adapted to provide a stability control actuation signal which is passed down the powerline to the adjacent trailer and to the tractor.

FIG. 5 shows a similar schematic arrangement as FIG. 3 where the pressure control module ECU 13 is located on the second trailer 202 instead of the first trailer and operates in a similar way.

In all of the embodiments described with respect to FIGS. 2-5, in the event that the lateral acceleration sensor 50 on the trailer in the road train detects lateral acceleration or an RSP event, then by setting the stability control actuation signal to active, roll stability control can be actuated on the trailer with the electronic braking system and the brakes applied on the trailer without electronic braking, thereby enabling the trailer to emulate the stability control of a full electronic braking system. In particular, in the case where there is likely to be over steer and braking in one trailer will result in other trailers jack-knifing, brake force can be applied to trailers which do not have EBS to correct this. The emulated stability control is therefore actuatable based on information from the communication interface rather than from sensors on that trailer.

The effectiveness of the roll stability control intervention can be enhanced by modifying the thresholds on the roll stability control program of the EBS trailer based on data from the non-EBS trailer, where this, for example, transmits the wheel speed signals to the pressure control module 13. If the wheel speed is within acceptable predetermined limits on the non-EBS trailer, then the brake force there could be maintained, i.e. no additional braking effort applied or alternatively a reduced braking effort. The stability of the whole road train can therefore be improved with respect to the use of roll stability on a single trailer.

In the above description of a specific embodiment of the invention, it has been assumed that there is a separate lateral acceleration sensor installed on one of the trailers. However, it is also possible to detect instability when two or more wheel speed sensors are installed on the same trailer. Although the invention has been specifically described as being an electropneumatic brake system, it would be possible to use for one trailer a fully electric system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A trailer braking system for a vehicle having at least first and second trailers, the system comprising:
a braking system of the first trailer comprising a brake capable of generating a brake force on an axle on the first trailer, the brake force being controllable by a first braking ECU in dependence on an output of a sensor adapted to detect at least one of lateral acceleration and wheel speed of the first trailer;
a second braking system of the second trailer comprising a brake capable of generating a brake force on an axle of the second trailer, the brake force being controllable by an ABS valve;
a communication interface being operatively configured such that the ABS valve is controllable by the first braking ECU; and
wherein, in an event that the sensor detects lateral acceleration and/or a wheel speed indicative of loss of stability, the sensor generates a signal for actuating stability control in the first trailer and the first braking ECU generates a signal to apply the brakes of the second trailer.

2. The braking system according to claim 1, wherein the communication interface is one of a CAN bus and powerline carrier.

3. The braking system according to claim 1, wherein the sensor is at least one of a lateral acceleration sensor and a plurality of wheel speed sensors.

4. The braking system according to claim 2, wherein the sensor is at least one of a lateral acceleration sensor and a plurality of wheel speed sensors.

5. The braking system according to claim 1, wherein the sensor generates a signal only when the detected lateral acceleration exceeds a predetermined threshold.

6. The braking system according to claim 2, wherein the sensor generates a signal only when the detected lateral acceleration exceeds a predetermined threshold.

7. The braking system according to claim 1, wherein the first braking ECU monitors wheel speed on the first trailer, and wherein stability control is initiated as a function of whether the vehicle is braked or unbraked via a braking intervention by monitoring rotational wheel speed behavior.

8. The braking system according to claim 1, wherein in a case of a braked vehicle, the brake force is lowered at a braked wheel on an inside of a turn and a stability control event is initiated if the rotational speed of the wheel increases by less than a predetermined amount.

9. A method of operating a braking system of a motor vehicle having at least a first and a second trailer, the method comprising the acts of:
detecting in the first trailer, which is equipped with a braking ECU for controlling a brake force, a signal indicative of loss of stability;
generating a signal for actuating stability control in the first trailer; and
generating, by the braking ECU of the first trailer, a signal to apply brakes on the second trailer, which is equipped with an ABS valve for controlling a brake force of the second trailer.

10. The method according to claim 9, further comprising the act of communicating the signal to apply the brakes of the second trailer from the first braking ECU via a CAN bus or powerline carrier.

11. The method according to claim 9, wherein the signal indicative of loss of stability is at least one of a lateral acceleration signal and a wheel speed signal.
